(19) United States
(12) Patent Application Publication
(10) Pub. No.: US 2018/0053314 A1
(43) Pub. Date: Feb. 22, 2018

(54) MOVING OBJECT GROUP DETECTION DEVICE AND MOVING OBJECT GROUP DETECTION METHOD

(71) Applicant: FUJITSU LIMITED, Kawasaki-shi (JP)

(72) Inventors: Kentaro TSUJI, Kawasaki (JP); EIGO SEGAWA, Kawasaki (JP); Mingxie Zheng, Kawasaki (JP); Yuji Matsuda, Kawasaki (JP); Nobuhiro Miyazaki, Kawasaki (JP)

(73) Assignee: FUJITSU LIMITED, Kawasaki-shi (JP)

(21) Appl. No.: 15/647,988

(22) Filed: Jul. 12, 2017

(30) Foreign Application Priority Data
Aug. 17, 2016 (JP) 2016-160197

(51) Int. Cl. G06T 7/292; G06T 7/215; G06T 7/246; G06K 9/32

(52) U.S. Cl. CPC G06T 7/292; G06T 7/215; G06T 2207/30196; G06K 9/3241; G06T 7/246

(57) ABSTRACT

A moving object group detection method includes: respectively analyzing a first captured image captured by a first image capture device and a second captured image captured by a second image capture device, and respectively extracting a first image region and a second image region from the first captured image and the second captured image, the first image region and the second image region being regions in which coloring patterns satisfy a predetermined similarity range and moving in corresponding directions over plural frames; and detecting that a common moving object group is included in the first image region and the second image region on the basis of an evaluation of similarity between an image within the first image region and an image within the second image region.

### CROSS-REFERENCE TO RELATED APPLICATION

This application is based upon and claims the benefit of priority of the prior Japanese Patent Application No. 2016-160197, filed on Aug. 17, 2016, the entire contents of which are incorporated herein by reference.

### FIELD

The embodiments discussed herein are related to a recording medium storing a moving object group detection program, a moving object group detection device, and a moving object group detection method.

### BACKGROUND

Technology that tracks persons using footage captured by a monitoring camera was known hitherto.

For example, there is a proposal for a person tracking device that detects a person region, which is a region assigned to a person included in footage, and generates person region information detailing information regarding the person region. The person tracking device chooses a distinctive person, who is a person having a specific feature amount, from amongst passersby accompanying a tracking-target person, and computes a distinctive person tracking result that is a tracking result for the distinctive person. Then, the person tracking device computes a tracking result for the tracking-target person from the distinctive person tracking result and from tracking-target person relative position information representing the position of the distinctive person relative to the tracking-target person.

### RELATED PATENT DOCUMENTS

International Publication Pamphlet No. WO 2012/131816

### SUMMARY

According to an aspect of the embodiments, a non-transitory recording medium storing a moving object group detection program causes a computer to execute a process. The process includes: respectively analyzing a first captured image captured by a first image capture device and a second captured image captured by a second image capture device, and respectively extracting a first image region and a second image region from the first captured image and the second captured image, the first image region and the second image region being regions in which coloring patterns satisfy a predetermined similarity range and moving in corresponding directions over plural frames; and detecting that a common moving object group is included in the first image region and the second image region on the basis of an evaluation of similarity between an image within the first image region and an image within the second image region.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for explaining an example of a method of tracking a person using captured images.

FIG. 2 is a diagram illustrating an example of feature information extracted from captured images.

FIG. 3 is a diagram illustrating an example of a captured image in a crowded environment.

FIG. 4 is a diagram illustrating an example of erroneous associations between persons in a crowded environment.

FIG. 5 is a functional block diagram illustrating a schematic configuration of a moving object group tracking system according to an exemplary embodiment.

FIG. 6 is an explanatory diagram for explaining an outline of processing of a moving object group tracking system according to an exemplary embodiment.

FIG. 7 is a diagram illustrating an example of a method of extracting color features.

FIG. 8 is a diagram illustrating an example of data stored in a color feature information storage section.

FIG. 9 is a diagram illustrating an example of a method of deriving a flow of each small region in captured images of plural frames.

FIG. 10 is a diagram illustrating an example of a method of deriving feature extraction ranges based on a flow of each small region in captured images of plural frames.

FIG. 11 is an explanatory diagram for explaining setting of a feature extraction range in cases in which a small number of frames is read.

FIG. 12 is an explanatory diagram for explaining a similarity evaluation of color features across captured images having different image capture device IDs.

FIG. 13 is a diagram illustrating an example of a method for computing a degree of similarity between pairs of associated color features in cases in which the sizes of the associated color features are different.

FIG. 14 is a diagram illustrating an example of a case in which degrees of similarity computed from portions of regions of associated color features are employed in combination.

FIG. 15 is a diagram illustrating an example of a table collecting a number of people included in the crowd of people and movement durations of the crowd of people.

FIG. 16 is a block diagram illustrating a schematic configuration of a computer that functions as a moving object group tracking device according to an exemplary embodiment.

FIG. 17 is a flowchart illustrating an example of moving object group tracking processing of an exemplary embodiment.

### DESCRIPTION OF EMBODIMENTS

### Tracking of Objects Based on Captured Images

A case is considered in which persons, serving an example of objects, are tracked based on captured images and movement trends of the persons are acquired. In this case, conceivably, persons are detected from captured images captured by plural image capture devices, associations are made between persons detected from each captured image, and the movement path of each person is generated in accordance with the association results.

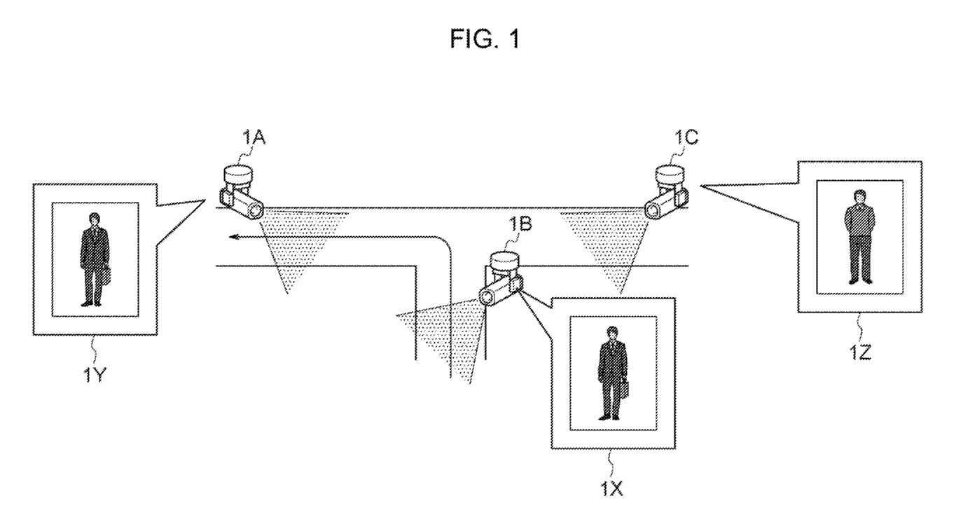

For example, an example is considered of a case in which an image capture device 1A, and image capture device 1B, and an image capture device 1C serve as the plural image capture devices, as illustrated in FIG. 1. In the example illustrated in FIG. 1, a person 1Y is pictured in a captured image captured by the image capture device 1A, a person 1X is pictured in a captured image captured by the image capture device 1B, and a person 1Z is pictured in a captured image captured by the image capture device 1C.

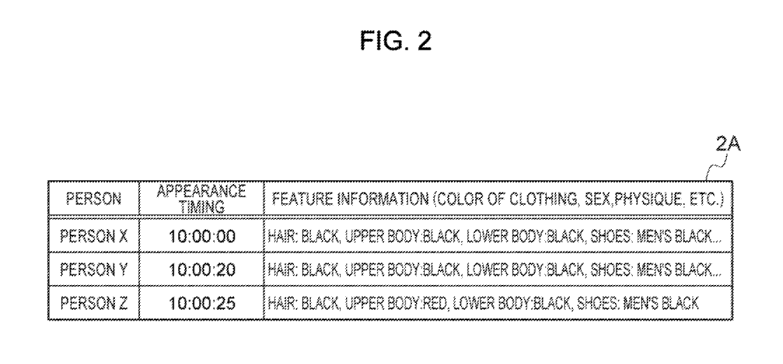

When captured images are acquired, regions representing persons are detected from each captured image and the color of the clothing of the person, the sex of the person, the physique of the person, and the like are extracted as feature information like in table 2A illustrated in FIG. 2. Note that feature information such as sex and physique can be extracted using an identification model or the like pre-generated for identifying these pieces of information. Further, appearance times according to the time at which the captured image was captured are allocated to the detected persons. Then, each item of extracted feature information is compared, and persons are determined to be the same person in cases in which the feature information is similar. In the example illustrated in FIG. 1, the person 1Y of the captured image captured by the image capture device 1A and the person 1X of the captured image captured by the image capture device 1B are determined to be the same person, and a movement path from the position of the image capture device 1B to the position of the image capture device 1A is acquired as the movement trend of the person.

Note that, in cases in which little feature information can be extracted from the tracking-target person, the same person may conceivably be associated across image capture devices by detecting distinctive persons from amongst persons surrounding a tracking-target person and making associations with the tracking-target person in accordance with their positions relative to the distinctive person.

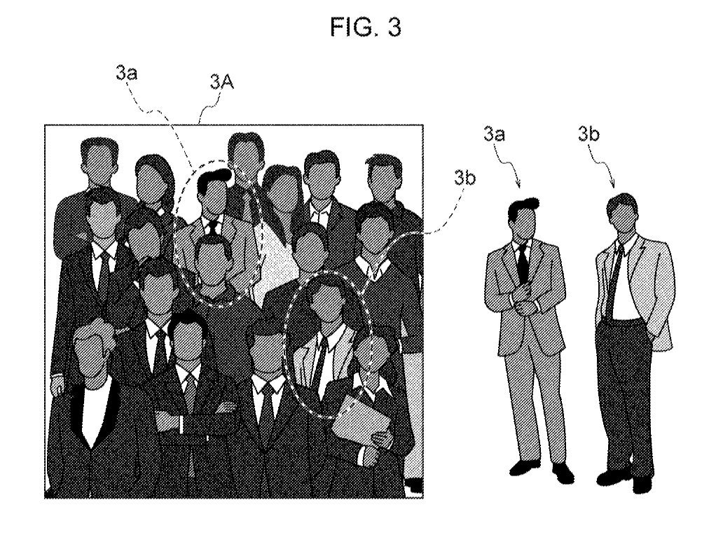

Here, a case is considered in which associations between persons are made using distinctive persons present in the surroundings of the tracking-target person in a highly crowded environment. As illustrated in FIG. 3, features of persons in a crowded environment are liable to be similar. For example, in a captured image 3A illustrated in FIG. 3, even though the color of the pants differs between a person 3a and a person 3b, the pants portion is hidden in crowded conditions.

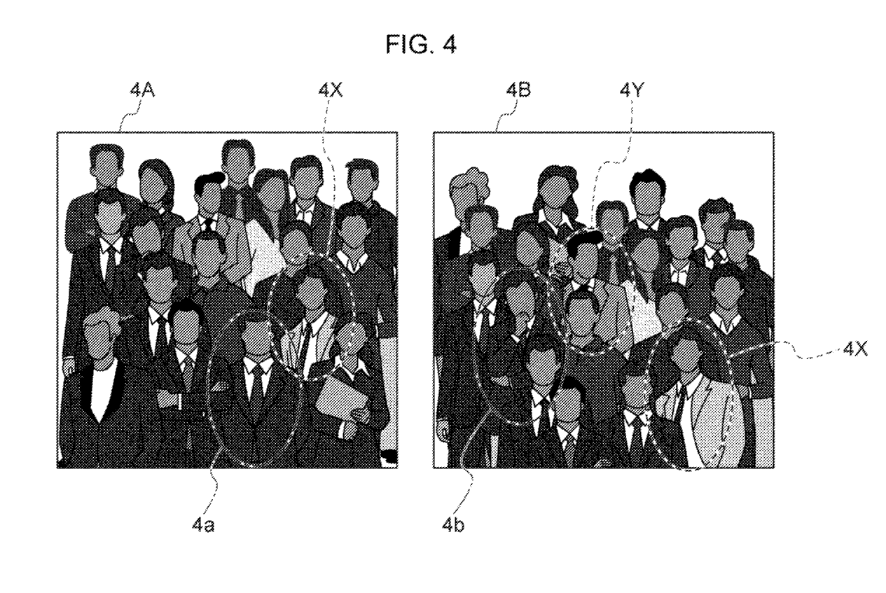

Accordingly, in a highly crowded environment, features of a distinctive person 4X present in the surroundings of the tracking-target person 4a are hidden in a captured image 4A captured by the image capture device A, as illustrated in FIG. 4. An erroneous association that sets the person 4Y as the distinctive person may therefore be generated in a captured image 4B captured by an image capture device B, and the tracking-target person estimated from a relative position may also be erroneously associated as the person 4b.

However, it is conceivable that the relative positions of persons due to movement will undergo little change in a highly crowded environment since overtaking is difficult. Accordingly, there is a low need to track each person individually when movement trends of people are acquired from the number of people included in a crowd of people, the movement path of a crowd of people, the movement duration of a crowd of people, and the like.

A moving object group tracking system of the present exemplary embodiment therefore not only compares features of each person across captured images captured by each image capture device, but also collects and compares color information of plural persons nearby in the captured images for use in making associations. This increases the features employed in making associations, and enables movement trends of people to be acquired, even when individual associations are not achievable, since associations are made as a crowd of people.

Detailed description follows regarding an example of technology disclosed herein, with reference to the drawings.

### Exemplary Embodiment

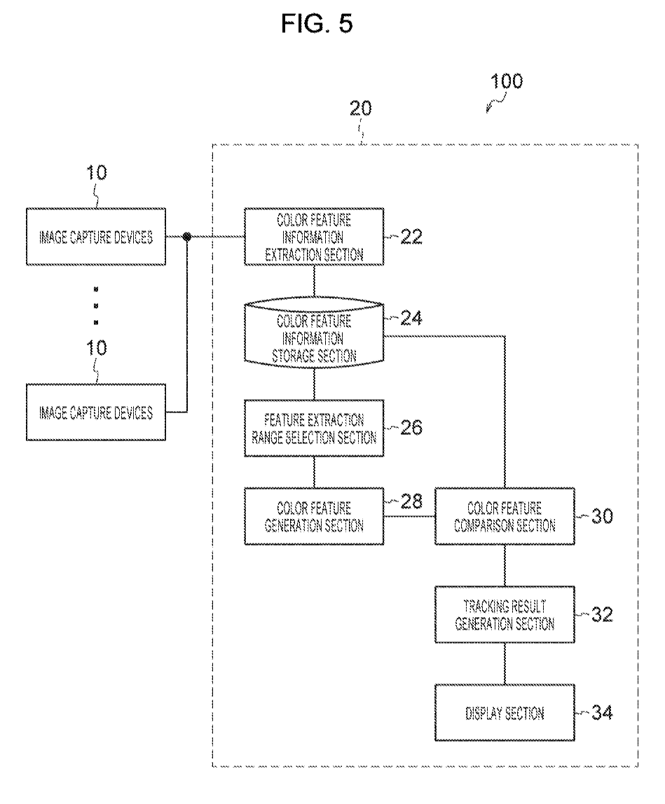

As illustrated in FIG. 5, a moving object group tracking system 100 according to the present exemplary embodiment includes plural image capture devices 10 and a moving object group tracking device 20.

The image capture devices 10 capture captured images that include a crowd of people as an example of a moving object group. Note that an ID is allocated to each of the plural image capture devices 10. Further, the image capture device ID and an image capture timing representing the frame are allocated to the captured images captured by the image capture devices 10.

The moving object group tracking device 20 analyzes each captured image captured by the plural image capture devices 10 and determines the movement course of the crowd of people and the number of people included in the crowd of people. As illustrated in FIG. 5, the moving object group tracking device 20 includes a color feature information extraction section 22, a color feature information storage section 24, a feature extraction range selection section 26, a color feature generation section 28, a color feature comparison section 30, a tracking result generation section 32, and a display section 34. The feature extraction range selection section 26 is an example of an extraction section of technology disclosed herein, the color feature comparison section 30 and the tracking result generation section 32 are examples of a detection section of technology disclosed herein.

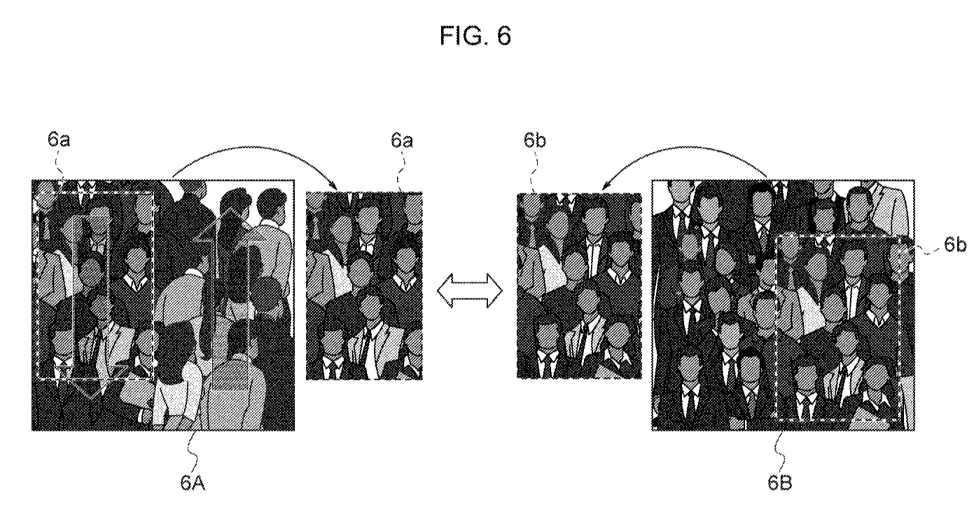

In the moving object group tracking device 20 according to the present exemplary embodiment, a region 6a indicating a crowd of people moving in substantially the same direction is extracted from a captured image 6A captured by an image capture device A, as illustrated in FIG. 6. The region 6a is a region that moves in substantially the same direction over plural frames of the captured image 6A, and that has little change in the arrangement of color. Further, the moving object group tracking device 20 also extracts a region 6b indicating a crowd of people moving in substantially the same direction from a captured image 6B captured by a different image capture device B.

The moving object group tracking device 20 determines that a region having a high degree of similarity when comparing the region 6a against the region 6b is the same crowd of people. A movement trend of the crowd of people is then extracted from the image capture timings of each captured image in which the crowd of people was determined to be the same, and from the positional relationships between the image capture devices.

Thus, the moving object group tracking device 20 according to the present exemplary embodiment increases the features employed in making associations by comparing color information across image capture devices in ranges of regions that move in substantially the same direction in the captured images. Making associations in crowds of people across plural image capture devices is thereby implemented even in crowded environments.

The color feature information extraction section 22 acquires the captured images captured by the plural image capture devices 10. The color feature information extraction section 22 then associates the acquired captured images with the image capture device IDs and with the image capture timings representing the frames. Further, the color feature information extraction section 22 extracts color features from the captured image of each frame of each image capture device ID and stores the extracted color features in the color feature information storage section 24.

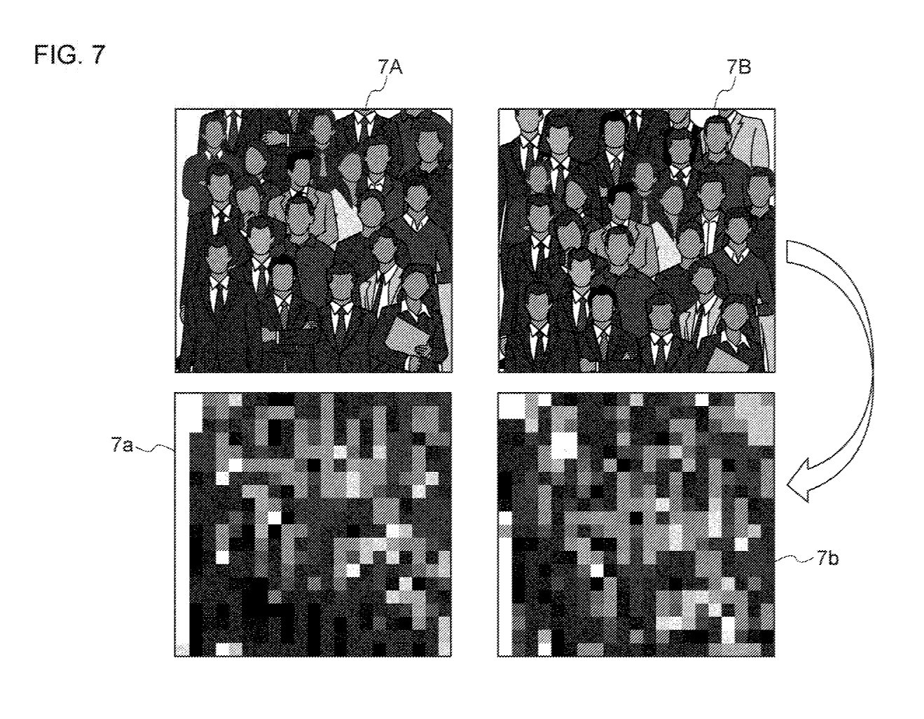

FIG. 7 illustrates an example of a method of extracting color features. FIG. 7 illustrates a captured image 7A of a specific frame captured by the image capture device A, and a captured image 7B of a specific frame captured by the image capture device B. The color feature information extraction section 22 extracts color features 7a from the captured image 7A and extracts color features 7b from the captured image 7B.

More specifically, the color feature information extraction section 22 divides entire captured image corresponding to each frame into blocks of a predetermined size (for example, 3×3 pixels). Next, as illustrated in FIG. 7, mentioned above, the color feature information extraction section 22 computes averages of the color components respectively for R, B, and G of each pixel in each block as color information. The color feature information extraction section 22 then associates color information corresponding to each block with the image capture device ID and image capture timing associated with the frame from which the color information was computed, and stores the association in the color feature information storage section 24. This enables, for example, slight changes in positional offset and color of people to be processed robustly by processing in block units of a predetermined size, rather than by employing the image information as-is.

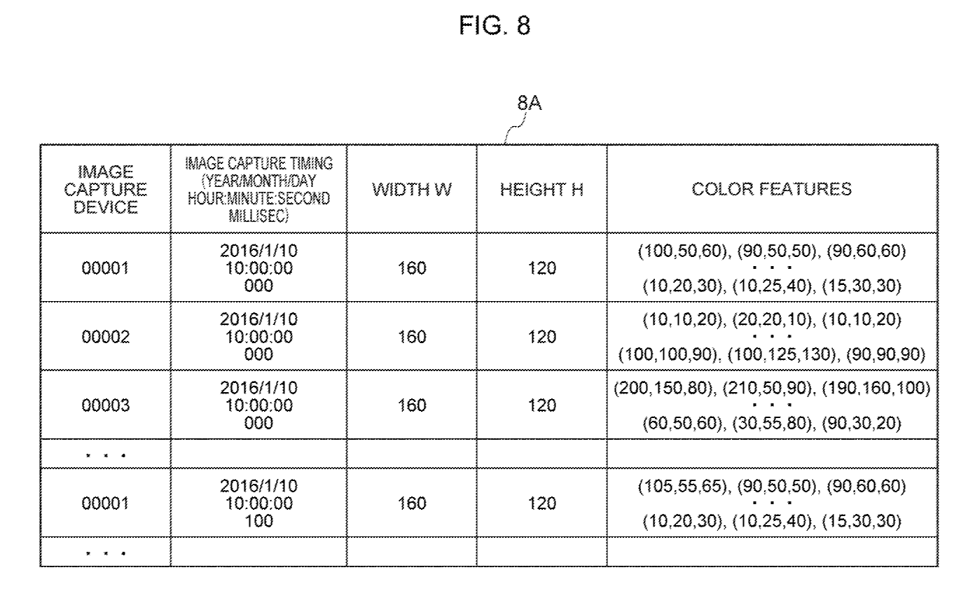

In the color feature information storage section 24, the color features extracted by the color feature information extraction section 22 are stored in a color feature information table in association with the image capture device ID and the image capture timing representing the frame. FIG. 8 illustrates an example of the color feature information table stored in the color feature information storage section 24. In the color feature information table 8A illustrated in FIG. 8, a size width W, a size height H, and the color feature are stored as color feature information associated with the image capture device ID and the image capture timing representing the frame. As the color features, the color information (R, G, B) within each block is stored written in sequence from the top-left block.

For each image capture device ID, the feature extraction range selection section 26 extracts a feature extraction range for each captured image of each frame having the same image capture device ID, based on the color features of the color feature information table. The feature extraction ranges are regions in which the color features, which are an example of a coloring pattern, satisfy a predetermined similarity range, and are regions having movement in a corresponding direction over plural frames.

More specifically, the feature extraction range selection section 26 first sets a number of frames within a pre-set duration and reads color features of the captured image of each frame having the same image capture device ID from the color feature information storage section 24. The feature extraction range selection section 26 then extracts the feature extraction ranges by comparing the color features of the captured image of each frame. Note that in cases in which, for example, the image resolution differs across different image capture devices, the size width W and the size height H of the color features of the color feature information table of the color feature information storage section 24 are set in accordance with the resolution and the color features of the captured images are read.

In the present exemplary embodiment, regions in which the color feature information has similar arrangements and in which there is movement in a given direction are extracted as the feature extraction ranges from the captured image of each frame having the same image capture device ID. For example, the feature extraction range selection section 26 determines the flow of each small region in the captured image of a specific frame and collects the ranges of each small region that indicate a flow in substantially the same direction. The feature extraction range selection section 26 performs a survey to find whether or not a range expressing a color feature similar to the color features within the ranges expressing a flow in substantially the same direction is also present in a captured image of another frame.

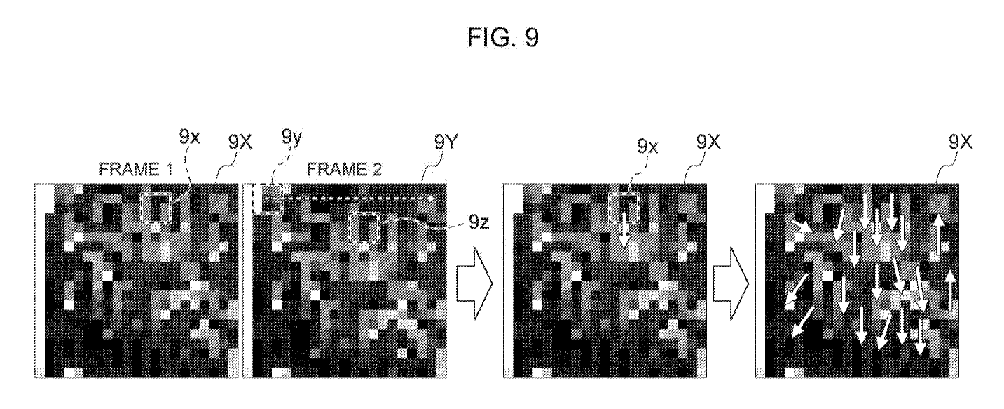

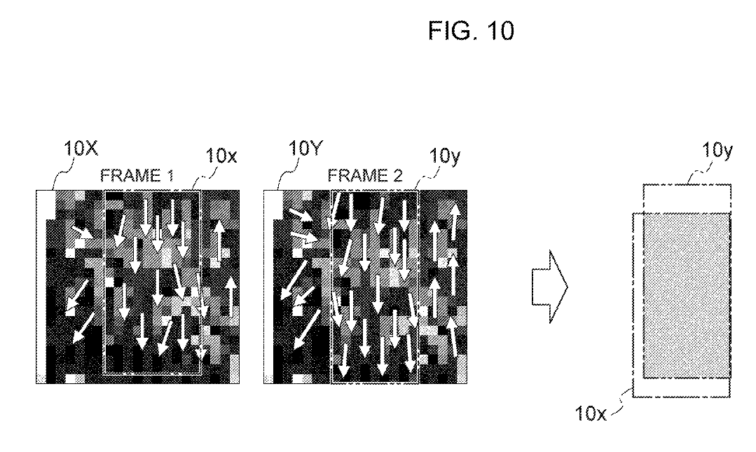

FIG. 9 illustrates an example of a method for deriving the flow in each small region. Further, FIG. 10 illustrates an example of a method for deriving feature extraction ranges based on the flow of the small regions.

For example, as illustrated in FIG. 9, the feature extraction range selection section 26 sets a predetermined small region 9x for a captured image 9X of a frame 1 for which a flow is to be derived (for example, a 3×3 block). Next, the feature extraction range selection section 26 also performs sequential setting of a small region 9y, which is a 3×3 block, so as to scan the captured image 9Y of a frame 2, which is the next frame. More specifically, the feature extraction range selection section 26 changes the position of the small region 9y in the captured image 9Y of the frame 2 and computes the degree of similarity in color features, representing the degree of similarity in the types and arrangement of colors across the small regions, between the small region 9x of the frame 1 and each small region 9y of the frame 2.

The degree of similarity in color features is, for example, computed using the following method. For example, the degree of similarity in color between blocks corresponding to inside small regions can be calculated according to Equation (1) or Equation (2) below, where (R₁, B₁, G₁) is the color information of a block of a small region of the frame 1 and (R₂, B₂, G₂) is the color information of a block of a small region of the frame 2. Equation (1) is a calculation equation for calculating a value of correlation between the color information (R₁, B₁, G₁) and the color information (R₂, B₂, G₂), and Equation (2) is a calculation equation for calculating a distance between the color information (R₁, B₁, G₁) and the color information (R₂, B₂, G₂). The degree of similarity in the color features is computed such that the degree of similarity in colors between the blocks calculated for each block across the small regions in accordance with Equation (1) and Equation (2) below is the averaged value of the entire range of the small region.

For each small region included in the captured image of each frame, a flow representing what position each small region moved to in the next frame can be extracted by computing the degree of similarity in the color features. Each flow is expressed as a vector from the position of the small region at the movement origin to the position of the small region at the movement destination.

$$\begin{matrix}cor = \frac{{R}_{1} {R}_{2} + {G}_{1} {G}_{2} + {B}_{1} {B}_{2}}{\sqrt{( {R}_{1}^{2} + {G}_{1}^{2} + {B}_{1}^{2} ) ( {R}_{2}^{2} + {G}_{2}^{2} + {B}_{2}^{2} )}} & ( 1 ) \\ dis = \sqrt{{( {R}_{1} - {R}_{2} )}^{2} + {( {G}_{1} - {G}_{2} )}^{2} + {( {B}_{1} - {B}_{2} )}^{2}} & ( 2 )\end{matrix}$$

As illustrated in FIG. 9, the feature extraction range selection section 26 then sets, as a region corresponding to the small region 9x of the frame 1, a small region 9z having a degree of similarity in color features that was the highest computed value of degree of similarity out of the small regions 9y of the frame 2. A vector from the small region 9a to a small region 9c having the highest value of the degree of similarity serves as the flow corresponding to the small region 9x of the frame 1. The feature extraction range selection section 26 computes the flow for all of the small regions within the captured image of each frame. The flow of each small region can accordingly be computed by finding positions where color features that are similar across frames are present.

Next, the feature extraction range selection section 26 collects similar flows from flow groups that are respective flows of each small region. The processing that collects the flows is performed in each frame.

For example, for the captured image of each frame, the feature extraction range selection section 26 selects one target flow and allocates a predetermined label. The feature extraction range selection section 26 then finds the degree of similarity in flow between the target flow and flows that are in the surroundings of the target flow. For example, values of correlations between the vectors representing the flows, values of distance between the vectors representing the flows, or the like can be employed as the degree of similarity of the flows. The flows in the surroundings of the target flow are set with a pre-set range.

The feature extraction range selection section 26 then allocates the same label as that of the target flow to flows in the surroundings of the target flow in cases in which the degree of similarity of the flow is higher than a predetermined threshold value. On the other hand, the feature extraction range selection section 26 does not allocate a label in cases in which the degree of similarity of the flow is the predetermined threshold value or less.

For the captured image of each frame, the feature extraction range selection section 26 repeatedly changes the target flow to be observed and performs the processing to allocate labels, and small regions corresponding to flows allocated with the same label are collected after determining the allocation of labels for all of the flows. For example, as illustrated in FIG. 10, the feature extraction range selection section 26 generates a collection region 10x by collecting small regions corresponding to flows allocated the same label in a captured image 10X of the frame 1.

Then, for the captured image of each frame, the feature extraction range selection section 26 checks whether a collection region similar to the collection region in which the small regions corresponding to the flow allocated the same label in the captured image are collected is present in a captured image of a different frame. The feature extraction range selection section 26 then extracts, as the feature extraction range, a collection region that is similar over plural frames.

More specifically, for the captured image of each frame, the feature extraction range selection section 26 computes a degree of similarity in color features between the collection region of the captured image and the collection regions of the captured images of other frames. As the computation method for the degree of similarity related to the color features in the collection regions, for example, the feature extraction range selection section 26 first overlaps collection regions of captured images of different frames and finds the degree of similarity in the color features in the overlapped ranges. The feature extraction range selection section 26 then extracts as the feature extraction range, which is a common region, the overlapped regions at the position having the highest value for the degree of similarity in the color features.

For example, as illustrated in FIG. 10, the feature extraction range selection section 26 finds the degree of similarity in the color features between the color features of a region 10a of the captured image 10A of the frame 1 and the color features of a region 10b of the captured image 10B of the frame 2 while shifting the positions of the region 10a and the region 10b with respect to each other. The feature extraction range selection section 26 then extracts, as a common region, the overlapped region at a position where the degree of similarity in the color features has the highest value.

Note that plural collection regions are present in a single captured image of a frame in some cases. In such cases, the feature extraction range selection section 26 computes the degree of similarity in the color features for each pair of collection regions of different captured images. The overlapped region in the pair in which the degree of similarity in the color features has the highest value is then extracted as the common region.

The feature extraction range selection section 26 extracts regions common to all of the frames by making associations between the collection regions across all of the frames, and the feature extraction range selection section 26 extracts the common regions as the feature extraction ranges. The extracted feature extraction ranges extracted in this manner can be considered to be crowds of people moving in a specific direction.

The color feature generation section 28 reads, from the color feature information table of the color feature information storage section 24, color features corresponding to the feature extraction range selected by the feature extraction range selection section 26, and determines whether or not those color features are suitable for association across captured images having different image capture device IDs.

Then, in cases in which it was determined that the color features corresponding to the feature extraction range selected by the feature extraction range selection section 26 are not suitable for association, the color feature generation section 28 outputs a signal to the feature extraction range selection section 26 so that the feature extraction range is broadened. On the other hand, in cases in which it was determined that the color features corresponding to the feature extraction range selected by the feature extraction range selection section 26 are suitable for association, the color feature generation section 28 outputs the color features corresponding to the selected feature extraction range to the color feature comparison section 30 as associated color features. The associated color features are employed to make associations across captured images having different image capture device IDs in the color feature comparison section 30, described later.

A method is considered in which the variance of color features included in a feature extraction range is employed as an example of a determination method that determines whether or not the color features corresponding to the feature extraction range are suitable for association across captured images having different image capture device IDs. For example, in cases in which the value of a variance of color features included in the feature extraction range is a particular value or less, few features are included in the extracted feature extraction range and the extracted feature extraction range is conceivably not suitable for association. The color feature generation section 28 thus determines that the feature extraction range is not suitable for association across captured images having different image capture device IDs in cases in which the value of the variance of the color features included in the feature extraction ranges selected by the feature extraction range selection section 26 is the particular value or less.

Further, another example of a determination method that determines whether or not the color features corresponding to the feature extraction range are suitable for association across captured images having different image capture device IDs is a method that compares color features within plural feature extraction ranges extracted as the common regions in each frame within a predetermined duration. In this method, determination is made as to whether or not the color features within the specific feature extraction range are similar to the color features within another feature extraction range. In cases in which the color features within the specific feature extraction range are similar to the color features within another feature extraction range, it is clear that color features within the specific feature extraction range are present in various captured images. Employing color features within that specific feature extraction range to make associations is therefore conceivably highly likely to result in erroneous associations. Accordingly, for each selected combination of feature extraction ranges, the color feature generation section 28 determines that the feature extraction range is not suitable for association in cases in which the degree of similarity in the color features included in the feature extraction ranges in the combination is a particular value or higher.

Then, in cases in which it was determined that the feature extraction ranges selected by the feature extraction range selection section 26 are not suitable for association, the color feature generation section 28 outputs a signal to the feature extraction range selection section 26 so that a larger feature extraction range is set.

When the feature extraction range selection section 26 acquires the signal output from the color feature generation section 28, the feature extraction range selection section 26 sets a feature extraction range that is larger than the feature extraction range set in the processing the previous time.

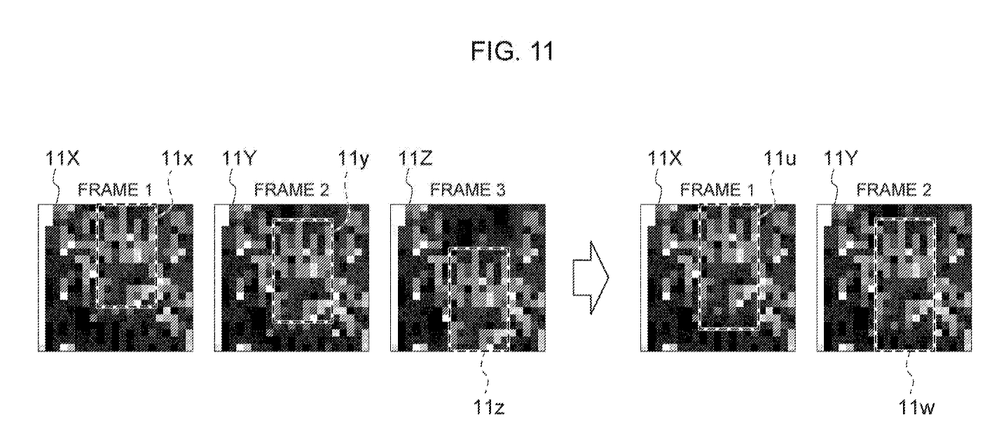

For example, as an example of processing to set a larger feature extraction range, the feature extraction range selection section 26 makes the number of frames read from the color feature information table of the color feature information storage section 24 smaller. FIG. 11 is a diagram for explaining setting of feature extraction ranges in cases in which the number of read frames is small.

As illustrated at the left side of FIG. 11, an example is considered of a case in which a feature extraction range 11x of a captured image 11X of a frame 1, a feature extraction range 11y of a captured image 11Y of a frame 2, and a feature extraction range 11z of a captured image 11Z of a frame 3 are set. In cases in which it was determined by the color feature generation section 28 that the feature extraction ranges are not suitable for association across captured images having different image capture device IDs, the read frames are set to the captured image 11X of the frame 1 and the captured image 11Y of the frame 2 as illustrated at the right side of FIG. 11. The lower the number of read frames, the lower the number of people moving outside of the image across the frames, such that the number of people present who are common to all of the frames becomes large and the feature extraction range can be selected as a broader range as a result. Thus, as illustrated in FIG. 11, for example, 11u and 11w, which are larger feature extraction ranges, are set by reducing the number of frames from 3 to 2. Thus, in the present exemplary embodiment, out of plural persons in the captured image, the feature amounts of plural persons are collected and extracted rather than just extracting the feature amounts of one person, and this enables the feature extraction range to be re-set until an effective feature amount is obtained.

The color feature comparison section 30 compares associated color features obtained by the color feature generation section 28 across captured images having different image capture device IDs, and detects the common inclusion of a crowd of people in image regions of different captured images in accordance with a similarity evaluation of color features across captured images having different image capture device IDs.

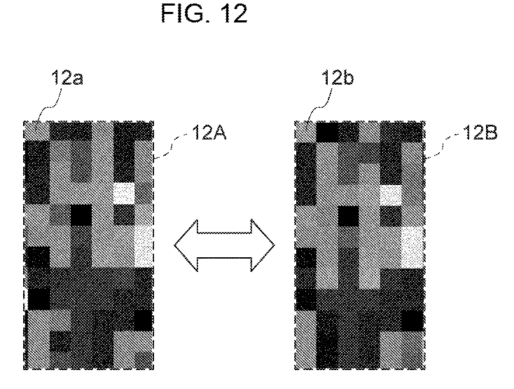

FIG. 12 is a diagram for explaining the similarity evaluation of the color features across captured images having different image capture device IDs. For example, consider a similarity evaluation of color features between associated color features 12A of a captured image captured by an image capture device A and associated color features 12B of a captured image captured by an image capture device B, as illustrated in FIG. 12. The color feature comparison section 30 computes a degree of color similarity between a block 12a and a block 12b, from out of the associated color features 12A and the associated color features 12B. The color feature comparison section 30 computes a degree of color similarity between blocks for each pair of all of the blocks present in corresponding positions out of the associated color features 12A and the associated color features 12B. At this time, the color feature comparison section 30, for example, as indicated by Equation (1) above or Equation (2) above, computes a value of correlation in color for each block, a distance between two colors in RGB color space, or the like as the degree of color similarity.

The color feature comparison section 30 then averages the degree of color similarity computed for each position within the associated color features over the entire range of the associated color features, and sets the obtained average as the degree of similarity of the associated color features between the associated color features 12A and the associated color features 12B. The color feature comparison section 30 then determines that the pair of associated color features of the associated color features 12A and the associated color features 12B are the same in cases in which the degree of similarity of the associated color features is a predetermined threshold value or higher.

Note that the color feature comparison section 30 selects an associated color feature other than the associated color features having the highest value of the degree of similarity in associated color features in cases in which there are plural other associated color features present that have a degree of similarity in associated color features of a predetermined threshold value or higher with specific associated color features. The color feature comparison section 30 then determines that the pair of the specific associated color features and the other selected associated color features are the same.

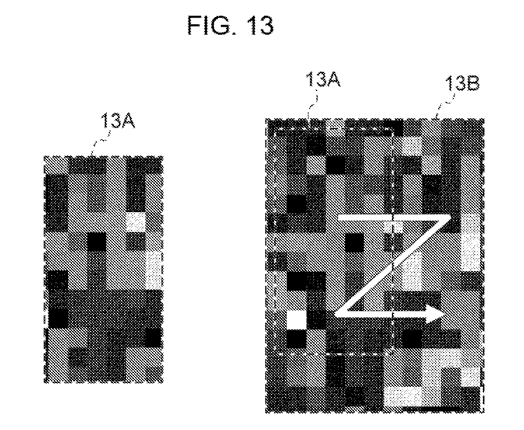

However, in the procedure of the present exemplary embodiment, the size of each associated color feature differs across the captured images of each image capture device ID in some cases. In such cases, the color feature comparison section 30 finds the degree of similarity of the associated color features while moving the associated color feature having the smaller size within the associated color features of the associated color feature having the larger size, out of the pair of associated color features obtained from captured images having different image capture device IDs. The color feature comparison section 30 then sets the maximum value out of the found degree of similarities in the associated color features as the degree of similarity of the associated color features in the pair. For example, as illustrated in FIG. 13, in a case in which the size of an associated color feature 13A is smaller than an associated color feature 13B, the degree of similarity of the associated color features is found while moving the associated color feature 13A within the associated color feature 13B.

Further, although plural persons are collected and compared in the present exemplary embodiment, a person present in a captured image captured by one image capture device goes out of sight and not is present in a captured image captured by another image capture device in some cases. Further, cases in which the feature extraction ranges are different ranges across image capture devices due to errors in extraction of flow from the captured image or the like are also conceivable.

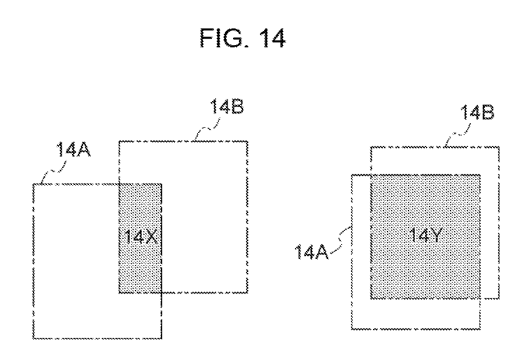

Therefore, for example, as illustrated in FIG. 14, for a pair of an associated color feature 14A and an associated color feature 14B obtained from different image capture device IDs, degrees of similarity computed from a portion of the region of the associated color feature may be employed in combination.

However, in cases in which degrees of similarity computed from a portion of the region of the associated color feature are employed, the comparison result for an associated color feature corresponding to a wider range has higher reliability that the comparison result for an associated color feature corresponding to a smaller range. Weighting is therefore performed such that the larger the region of the portion of the associated color feature, the higher the degree of similarity of the associated color feature.

For example, in the example illustrated in FIG. 14, in cases in which the degree of similarity is 80 in 14X and the degree of similarity is 60 in 14Y, the degree of similarity of 14X is higher than the degree of similarity of 14Y for the degree of similarity. However, in terms of the size of the overlapped regions, the overlapped region of the 14Y is larger than the overlapped region of the 14X, and the 14Y therefore has higher reliability than the 14X. Weightings are therefore performed in accordance with the sizes of the overlapped regions such that the greater the size of the overlapped region, the greater the degree of similarity of the associated color features.

Accordingly, the color feature comparison section 30 performs weighting on the degree of similarity of the associated color features computed when the associated color features are completely overlapped with each other as illustrated in FIG. 12, and the degree of similarity of the associated color features computed when portions of the associated color features are overlapped onto each other as illustrated in FIG. 14, in accordance with the overlapped regions. The color feature comparison section 30 then sets the degree of similarity of the associated color feature to the degree of similarity of the associated color feature computed using the weighting.

The tracking result generation section 32 computes the number of moving people included in the crowd of people using the size of the image region as the weight in cases in which an image region in which the crowd of people is commonly included across captured images having different image capture device IDs has been detected by the color feature comparison section 30. The image region in which the crowd of people is included is detected across captured images of each frame having different image capture device IDs. Thus, for example, in cases in which image regions that include the same crowd of people have been detected between a captured image captured at timing t by the image capture device A and a captured image captured at timing t+10 by the image capture device B, it is clear the crowd of people has moved from the image capture device A to the image capture device B in 10 seconds.

In cases in which the inclusion of the crowd of people has been detected, the tracking result generation section 32 identifies the movement course of the crowd of people in accordance with the detection result of the image region in which the inclusion of the crowd of people was detected. More specifically, the tracking result generation section 32 identifies the movement course of the crowd of people from position information regarding the pair of the image capture devices corresponding to the pair of image capture device IDs based on the pair of image capture device IDs of the captured images in which the associated color features have been associated.

Further, the tracking result generation section 32 computes a movement duration of the crowd of people across the different image capture devices in accordance with an extraction result of the image region across the different image capture device IDs. The movement duration of the crowd of people between different image capture devices is found in accordance with a difference between image capture timings of the pair of captured images in which the associated color features have been associated.

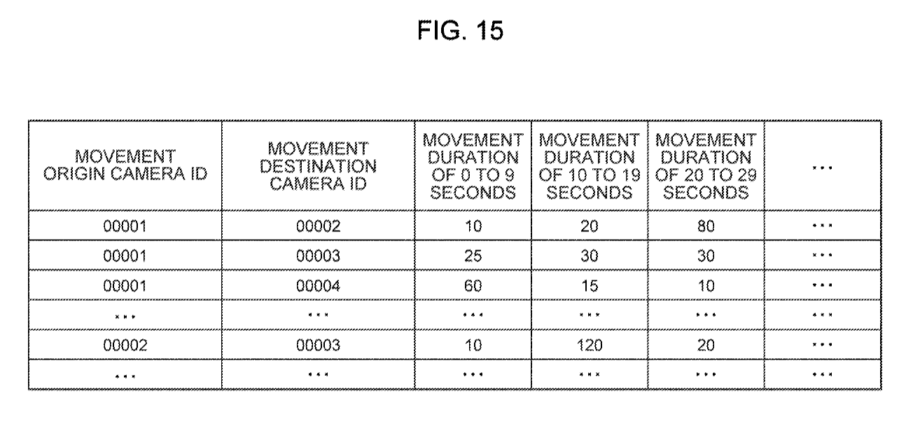

For example, as illustrated in FIG. 15, the tracking result generation section 32 generates a table collecting movement amounts of the crowd of people and movement durations of the crowd of people for each pair of image capture device IDs of a movement origin of the crowd of people and a movement destination of the crowd of people. In the table illustrated in FIG. 15, the movement amount of the crowd of people is displayed per movement duration for each pair of an image capture device ID of the movement origin and an image capture device ID of the movement destination.

As the generation method of the table illustrated in FIG. 15, for each pair of an image capture device ID of the movement origin and an image capture device ID of the movement destination, the tracking result generation section 32 first computes a movement duration in accordance with the difference between the image capture timings between the pairs of captured images in which the associated color features have been determined to be the same. The tracking result generation section 32 then computes a movement amount of the crowd of people per movement duration.

In cases in which a movement amount of the crowd of people is computed, when the size of the region of the associated color features is large, it is clear that a greater number of persons have moved across the image capture devices, and the tracking result generation section 32 therefore finds the number of moving people included in the crowd of people using the size of the region of the associated color features as a weight.

More specifically, the tracking result generation section 32, per pair of image capture device IDs in which the associated color features have been associated, counts, for example, each pixel as one person, and computes the number of moving people included in the crowd of people in accordance with the number of pixels in the associated color features within the captured image. This enables the number of moving people included in the crowd of people to be found using the size of the region of the associated color features as a weight.

The tracking result generation section 32 then stores, in a location corresponding to the movement duration of the table illustrated in FIG. 15, the number of moving people included in the crowd of people computed per movement duration. Note that the table illustrated in FIG. 15 is generated in duration ranges when finding the number of moving people included in the crowd of people per specific duration range.

For example, in the example of FIG. 15, detection results per pair of associated color features are accumulated and stored as the number of people included in the crowd of people moving from the movement origin image capture device ID “00001” to the movement destination image capture device ID “00002”. In the example illustrated in FIG. 15, it is clear that 10 people moved in the movement duration of from 0 seconds to 9 seconds, 20 people moved in the movement duration of from 10 seconds to 19 seconds, and 80 people moved in the movement duration of from 20 seconds to 29 seconds.

Accordingly, estimating the number of moving persons included in a crowd of people and the movement course by finding the number of moving people and the movement course for a crowd of people per duration range enables tracking of persons as a result.

The display section 34 displays the number of moving people and the movement course of the crowd of people obtained by the tracking result generation section 32 as a result.

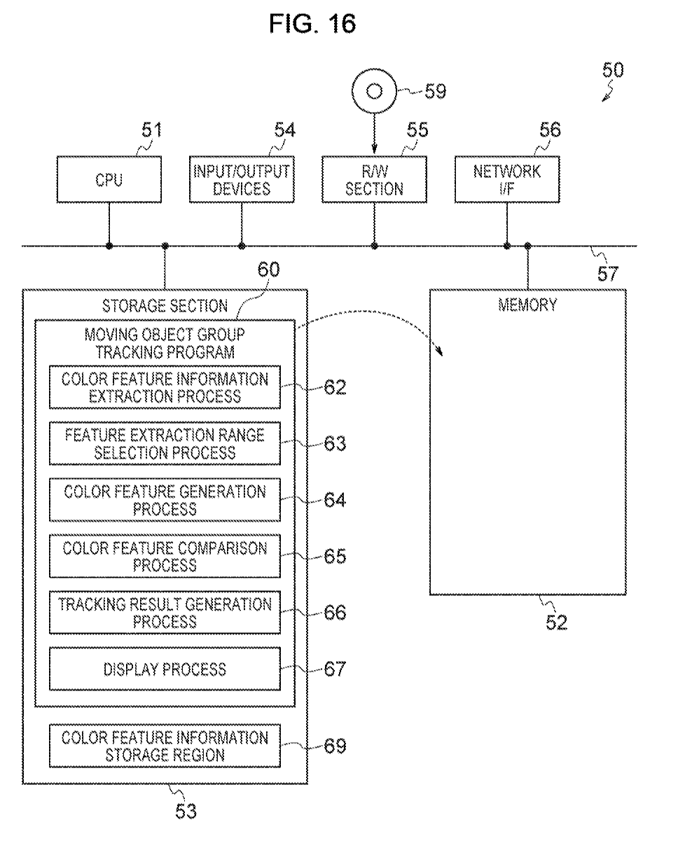

The moving object group tracking device 20 may, for example, be implemented by a computer 50 illustrated in FIG. 16. The computer 50 includes a CPU 51, memory 52 serving as a temporary storage region, and a non-volatile storage section 53. The computer 50 further includes input/output devices 54 such as a display device and an input device, and a read/write (R/W) section 55 that controls reading and writing of data from and to a recording medium 59. The computer 50 further includes a network interface (I/F) 56 connected to a network such as the internet. The CPU 51, the memory 52, the storage section 53, the input/output devices 54, the R/W section 55, and the network I/F 56 are connected to one another via a bus 57.

The storage section 53 may be implemented by a hard disk drive (HDD), solid state drive (SSD), flash memory, or the like. A moving object group tracking program 60 for causing the computer 50 to function as the moving object group tracking device 20 is stored in the storage section 53, which serves as a recording medium. The moving object group tracking program 60 includes a color feature information extraction process 62, a feature extraction range selection process 63, a color feature generation process 64, a color feature comparison process 65, a tracking result generation process 66, and a display process 67. The storage section 53 further includes a color feature information storage region 69 that stores the information included in the color feature information storage section 24.

The CPU 51 reads the moving object group tracking program 60 from the storage section 53, expands the moving object group tracking program 60 into the memory 52, and sequentially executes the processes included in the moving object group tracking program 60. The CPU 51 operates as the color feature information extraction section 22 illustrated in FIG. 6 by executing the color feature information extraction process 62. The CPU 51 also operates as the feature extraction range selection section 26 illustrated in FIG. 6 by executing the feature extraction range selection process 63. The CPU 51 also operates as the color feature generation section 28 illustrated in FIG. 6 by executing the color feature generation process 64. The CPU 51 also operates as the color feature comparison section 30 illustrated in FIG. 6 by executing the color feature comparison process 65. The CPU 51 also operates as the tracking result generation section 32 illustrated in FIG. 6 by executing the tracking result generation process 66. The CPU 51 also reads the information from the color feature information storage region 69 and expands the color feature information storage section 24 into the memory 52. The computer 50, which executes the moving object group tracking program 60, thereby functions as the moving object group tracking device 20.

Note that the functionality implemented by the moving object group tracking program 60 may be implemented by, for example, a semiconductor integrated circuit, and more specifically, by an application specific integrated circuit (ASIC) or the like.

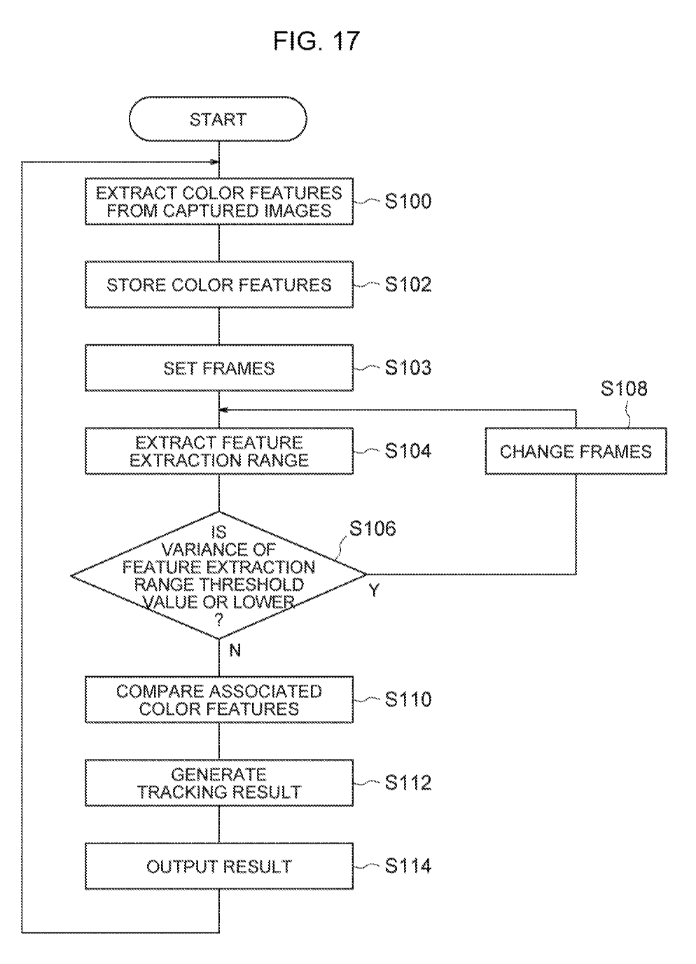

Next, the operation of the moving object group tracking system 100 according to an exemplary embodiment is described. For example, in the moving object group tracking system 100, the moving object group tracking processing illustrated in FIG. 17 is executed in the moving object group tracking device 20 when the moving object group tracking device 20 is acquiring each captured image captured by the plural image capture devices 10. Each processing is described in detail below.

At step S100 of the moving object group tracking processing illustrated in FIG. 17, the color feature information extraction section 22 extracts color features from the captured image of each frame captured by the plural image capture devices 10.

Next, at step S102, the color feature information extraction section 22 stores, in the color feature information table of the color feature information storage section 24, the color features of the captured image of each frame of each image capture device ID extracted at step S100 above.

At step S103, the feature extraction range selection section 26 sets the plural frames that are targets for extraction of the feature extraction ranges.

At step S104, for each image capture device ID, the feature extraction range selection section 26 reads the color features of the captured image of the plural frames set at step S103 above or at step S108 the previous time from the color feature information table. Then, based on the color features read from the color feature information table, the feature extraction range selection section 26 then extracts feature extraction ranges, which are regions in which the color features over plural frames satisfy a predetermined similarity range and are regions in which the movement is in a corresponding direction over plural frames. More specifically, for the captured image of each frame, the feature extraction range selection section 26 computes the degree of similarity in the color features across the collection region of that captured image and the collection region of a captured image of another frame. The feature extraction range selection section 26 then extracts, as feature extraction ranges that are common regions, overlapped regions in the position where the degree of similarity in the color features is the highest value.

At step S106, the color feature generation section 28 determines whether or not the feature extraction ranges selected by the feature extraction range selection section 26 are suitable for association across the captured images having different image capture device IDs. More specifically, the color feature generation section 28 computes the variance of the color features included in the feature extraction range extracted at step S104 above. Then, in cases in which the value of the variance is the particular value or less, the color feature generation section 28 determines that the feature extraction ranges are not suitable for association and processing transitions to step S108. On the other hand, in cases in which the value of the variance is greater than the particular value, the color feature generation section 28 determines that the feature extraction ranges are suitable for association and outputs the color features corresponding to the feature extraction ranges extracted at step S104 above as the associated color features, and processing proceeds to step S110.

At step S108, the feature extraction range selection section 26 sets a number of frames that is smaller than the number of frames set at step S103 above or at step S108 the previous time.

At step S110, the color feature comparison section 30 compares the associated color features output at step S106 above across captured images having different image capture device IDs. The color feature comparison section 30 performs a similarity evaluation of the color features across captured images having different image capture device IDs, and, for each pair of associated color features output at step S106 above, computes the degree of similarity of the associated color features across the captured images having different image capture device IDs. The color feature comparison section 30 then, for each captured image having a different image capture device ID, determines that the pair of associated color features are the same across the captured images having difference image capture device IDs in cases in which the degree of similarity of the associated color features is the predetermined threshold value or higher. The color feature comparison section 30 then detects that a common crowd of people is included the region of the associated color features that were determined to be the same. Note that in cases in which there are plural other associated color features for which the degree of similarity in the associated color feature with specific associated color feature is a predetermined threshold value or higher, the color feature comparison section 30 selects the other associated color feature that has the highest value of the degree of similarity in the associated color feature. The color feature comparison section 30 then determines that the pair of the specific associated color feature and the selected other associated color feature are the same.

At step S112, for each pair between the captured images having image capture device IDs detected to include a crowd of people at step S110 above, the tracking result generation section 32 computes the number of moving people included in the crowd of people using the size of the region as the weight for the number of moving people included in the crowd of people. Further, for each pair between the captured images having image capture device IDs detected to include a crowd of people at step S110 above, the tracking result generation section 32 identifies the movement course of the crowd of people in accordance with the detection result of the region detected to include the crowd of people.

At step S114, the display section 34 displays, as the result, the number of moving people and the movement course of the crowd of people obtained at step S112 above.

As described above, the moving object group tracking device according to the exemplary embodiment analyzes each captured image captured by the plural image capture devices and extracts image regions in which the color features satisfy a predetermined similarity range and movement is in a corresponding direction over plural frames. Common crowds of people included in the image regions of the image capture devices captured by different image capture devices are then detected in accordance with the similarity evaluation of the regions of the images captured by the plural image capture devices. This enables persons to be tracked from images in cases in which tracking of an object is performed across images captured by plural difference image capture devices and plural objects are included in the images.

Further, a crowd of people can be tracked with greater precision by broadening the feature extraction range in cases in which color features corresponding the feature extraction range are not suitable for association across captured images having different image capture device IDs.

Further, in cases in which it is detected that a crowd of people is included in an image region, the number of persons included in a crowd of people along a movement path can be estimated by computing the number of moving people in the crowd of people using the size of the image region as a weight for the number of moving people included in the crowd of people. Further, the movement course of a crowd of people can be identified in accordance with an extraction result of the image regions.

Further, the moving object group tracking device according to the exemplary embodiment enables a movement duration of people to be acquired even when associations are not achieved for individuals, since associations are made across images using crowd of people, which is a collective. In particular, capturing images when persons are overlapping each other in crowded environments and the like enables movement durations of people across image capture devices to be acquired even in cases in which division into respective person regions is difficult, since associations are made without dividing into regions.

Further, even when distinctive persons are not present within the captured images, movement durations can be estimated with high precision since the features of plural persons within the images are employed.

Further, movement trends of people (for example, statistical quantities related to movement courses, movement durations, and the like) can be ascertained from captured images captured by image capture devices and employed in various applications such as in safety announcements to alleviate crowding and in marketing.

Further, movement trends of people in a broad range can be obtained by coordinating captured images captured by the plural image capture devices, thereby enabling effective policies to be made from more information. This enables, for example, effective policies to be made with regard to, for example, relatedness between shops and leveling out of flows of people in shopping mall areas overall.

Note that in the above, a mode was described in which the moving object group tracking program 60 is pre-stored (installed) to the storage section 53. However, there is no limitation thereto. The program according to technology disclosed herein may be provided in a mode recorded on a recording medium such as a CD-ROM, a DVD-ROM, USB memory, or the like.

Next, modified examples of the exemplary embodiment are described.

In the present exemplary embodiment, an example of a case in which the moving object group is a crowd of people was described. However, there is no limitation thereto. Another moving object group may serve as the target. For example, the moving object group may be a group of vehicles.

Further, in the present exemplary embodiment, an example of a case in which image regions are extracted using color features, which serve as an example of a coloring pattern, was described. However, there is no limitation thereto. For example, image regions may be extracted using patterns of edge features, which is an example of a pattern obtained from another feature.

Further, in the present exemplary embodiment, an example has been described of a case in which the number of frames read from the color feature information table is made smaller and a larger feature extraction range is set in cases in which feature extraction ranges are not suitable for association across captured images having different image capture device IDs. However, there is no limitation thereto. For example, the feature extraction range may be expanded by a predetermined number of pixels and the feature extraction range set larger in cases in which the feature extraction ranges are not suitable for association across captured images having different image capture device IDs.

Further, in the present exemplary embodiment, an example has been described of a case in which variances of color features included in feature extraction ranges are employed when determining whether or not the selected feature extraction ranges are suitable for association across captured images having different image capture device IDs. However, there is no limitation thereto. For example, as described above, color features within plural feature extraction ranges may be compared and determination made as to whether or not the feature extraction ranges are suitable for association across captured images having different image capture device IDs.

Further, out of degrees of color similarity corresponding respective positions within associated color features, the color feature comparison section 30 may determine blocks having high degrees of color similarity as being the same and may performing track that regards these blocks as being the same person.

When capturing a state in which objects are crowded together, an image including plural objects will be captured by the image capture device. For example, when tracking persons serving as examples of objects, a portion of each person may be hidden as a result of overlap between persons in the image caused by crowding, and feature amounts are liable to be similar for each person since the feature amount obtained for each person is reduced. This makes identification of the tracking-target person difficult, such that the tracking-target person is not trackable.

One aspect of technology disclosed herein enables an object to be tracked from images in cases in which plural objects are included in the images.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory recording medium storing a moving object group detection program that causes a computer to execute a process, the process comprising:
respectively analyzing a first captured image captured by a first image capture device and a second captured image captured by a second image capture device, and respectively extracting a first image region and a second image region from the first captured image and the second captured image, the first image region and the second image region being regions in which coloring patterns satisfy a predetermined similarity range and moving in corresponding directions over a plurality of frames; and
detecting that a common moving object group is included in the first image region and the second image region on the basis of an evaluation of similarity between an image within the first image region and an image within the second image region.

2. The non-transitory recording medium of claim 1, wherein, in the process:
the first image region and the second image region each include a crowd of people and are respectively extracted from the first captured image and the second captured image; and
a common crowd of people is detected to be included in the first image region and the second image region on the basis of the evaluation of the similarity between the image within the first image region and the image within the second image region.

3. The non-transitory recording medium of claim 1, wherein:
extracting the first image region and the second image region includes, in a case in which the extracted first image region and second image region are not suitable for associating the first image region with the second image region, broadening a range of the image regions and extracting the first image region and the second image region.

4. The non-transitory recording medium of claim 1, wherein the process further comprises:
in a case in which it has been detected that a moving object group is included, computing a number of moving objects included in the moving object group, using a size of the image regions as a weight for the number of moving objects included in the moving object group.

5. The non-transitory recording medium of claim 1, wherein the process further comprises:
in a case in which it has been detected that the moving object group is included, identifying a movement course of the moving object group, on the basis of extraction results of the first image region and the second image region in which it has been detected that the moving object group is included.

6. The non-transitory recording medium of claim 1, wherein:
extracting the first and second image regions includes, in a case in which a color variance in a coloring pattern included in the image regions is a particular value or less, broadening a range of the image regions and extracting the first image region and the second image region.

7. The non-transitory recording medium of claim 1, wherein:
extracting the first and second image regions includes, in a case in which a coloring pattern included in the extracted first image region or second image region is included a predetermined number of times or more in other image regions of captured images captured by an image capture device, broadening a range of the image regions and extracting the first image region and the second image region.

8. A moving object group detection device comprising:
a memory; and
a processor coupled to the memory, the processor being configured to:
respectively analyze a first captured image captured by a first image capture device and a second captured image captured by a second image capture device, and respectively extract a first image region and a second image region from the first captured image and the second captured image, the first image region and the second image region being regions in which coloring patterns satisfy a predetermined similarity range and moving in corresponding directions over a plurality of frames; and
detect that a common moving object group is included in the first image region and the second image region on the basis of an evaluation of similarity between an image within the first image region and an image within the second image region.

9. The moving object group detection device of claim 8, wherein:
the first image region and the second image region each include a crowd of people and are respectively extracted from the first captured image and the second captured image; and
a common crowd of people is detected to be included in the first image region and the second image region on the basis of the evaluation of the similarity between the image within the first image region and the image within the second image region.

10. The moving object group detection device of claim 8, wherein:
in a case in which the extracted first image region and second image region are not suitable for associating the first image region with the second image region, a range of the image regions is broadened and the first image region and the second image region are extracted.

11. The moving object group detection device of claim 8, wherein:
in a case in which it has been detected that a moving object group is included, a movement amount of the moving object group is computed using a size of the image regions as a weight for the movement amount of the moving object group.

12. The moving object group detection device of claim 8, wherein:
in a case in which it has been detected that the moving object group is included, a movement course of the moving object group is identified on the basis of extraction results of the first image region and the second image region in which it has been detected that the moving object group is included.

13. The moving object group detection device of claim 8, wherein:
in a case in which a color variance in a coloring pattern included in the image regions is a particular value or less, a range of the image regions is broadened and the first image region and the second image region are extracted.

14. The moving object group detection device of claim 8, wherein:
in a case in which a coloring pattern included in the extracted first image region or second image region is included a predetermined number of times or more in other image regions of captured images captured by an image capture device, a range of the image regions is broadened and the first image region and the second image region are extracted.

15. A moving object group detection method comprising:
by a processor,
respectively analyzing a first captured image captured by a first image capture device and a second captured image captured by a second image capture device, and respectively extracting a first image region and a second image region from the first captured image and the second captured image, the first image region and the second image region being regions in which coloring patterns satisfy a predetermined similarity range and moving in corresponding directions over a plurality of frames; and
detecting that a common moving object group is included in the first image region and the second image region on the basis of an evaluation of similarity between an image within the first image region and an image within the second image region.

16. The moving object group detection method of claim 15, wherein:
the first image region and the second image region each include a crowd of people and are respectively extracted from the first captured image and the second captured image; and
a common crowd of people is detected to be included in the first image region and the second image region on the basis of the evaluation of the similarity between the image within the first image region and the image within the second image region.

17. The moving object group detection method of claim 15, wherein:
extracting the first image region and the second image region includes, in a case in which the extracted first image region and second image region are not suitable for associating the first image region with the second image region, broadening a range of the image regions and extracting the first image region and the second image region.

18. The moving object group detection method of claim 15, wherein:
in a case in which it has been detected that a moving object group is included, a movement amount of the moving object group is computed using a size of the image regions as a weight for the movement amount of the moving object group.

19. The moving object group detection method of claim 15, wherein:
in a case in which it has been detected that the moving object group is included, a movement course of the moving object group is identified on the basis of extraction results of the first image region and the second image region in which it has been detected that the moving object group is included.

20. The moving object group detection method of claim 15, wherein:
extracting the first and second image regions includes, in a case in which a color variance in a coloring pattern included in the image regions is a particular value or less, broadening a range of the image regions and extracting the first image region and the second image region.
